(19) United States
(12) Patent Application Publication
(10) Pub. No.: US 2008/0223968 A1
(43) Pub. Date: Sep. 18, 2008

(54) APPARATUS, SYSTEM, AND METHOD FOR CHECKING TAPE REEL MOTION

(76) Inventors: NHAN Xuan BUI, Tucson, AZ (US); Reed Alan Hancock, Tucson, AZ (US); Randy Clark Inch, Tucson, AZ (US); Eiji Ogura, Yokohama-shi (JP); Kazuhiro Tsuruta, Sagamihara (JP)

Correspondence Address: Kunzler & McKenzie, 8 EAST BROADWAY, SUITE 600, SALT LAKE CITY, UT, 84111, US

(21) Appl. No.: 11/686,840

(22) Filed: Mar. 15, 2007

(51) Int. Cl. G03B 1/58

(52) U.S. Cl. 242/332.1; 242/390.6

(57) ABSTRACT

An apparatus, system, and method are disclosed for checking tape reel motion. A control module directs a leading servo to apply torque to a leading reel and a trailing servo to apply torque to a trailing reel, wherein the control module directs the leading servo to apply an initial positive torque in a tape motion direction and directs the trailing servo to apply an initial negative torque counter to the tape motion direction. If there is no change in an angular position of the leading and trailing reels, the control module incrementally sums a first incremental positive torque to the leading torque to increase the leading torque and a second incremental positive torque to the trailing torque until there is a change in the angular position of the leading and trailing reels and/or until the torques exceed torque limits.

### BACKGROUND OF THE INVENTION

1. Field of the Invention

This invention relates to tape reels and more particularly relates to checking tape reel motion.

2. Description of the Related Art

Magnetic tape is often used to store large quantities of data economically. The magnetic tape may be coated with magnetic particles. A tape drive may magnetically encode data by polarizing areas of the magnetic particles in one of two directions. Areas with a first magnetic polarization may represent a first binary value such as zero (0) while areas with a second magnetic polarization may represent a second binary value such as one (1).

The magnetic tape may be stored on a first reel within a cartridge. When data is read from and/or written to the magnetic tape, a proximal end of the magnetic tape may be spooled to second reel. Servos may motivate the first and second reels to move the magnetic tape across a head. The head may include read and write elements that read magnetically encoded data from and write magnetically encoded data to the magnetic tape.

The magnetic tape may move in a tape motion direction from the first reel to the second reel and/or in a tape motion direction from the second reel to the first reel. Thus either the first or the second reel may be a leading reel, with the other reel configured as a trailing reel. The tape motion direction is from the trailing reel to the leading reel.

The magnetic tape moves in close proximity to the head. When the magnetic tape is stopped, the tape may become stuck to the head. If the magnetic tape becomes stuck, the leading reel may attempt to force the tape to move, potentially damaging the tape. Alternatively, the trailing reel may move magnetic tape toward the head, but because the tape is stuck to the head, the tape does not move past the head and instead unspools within the tape drive.

### SUMMARY OF THE INVENTION

From the foregoing discussion, there is a need for an apparatus, system, and method for checking tape reel motion. Beneficially, such an apparatus, system, and method would check tape reel motion, disengage a tape from a head, and communicate that the tape is stuck or not.

The present invention has been developed in response to the present state of the art, and in particular, in response to the problems and needs in the art that have not yet been fully solved by currently available systems for checking tape reel motion. Accordingly, the present invention has been developed to provide an apparatus, system, and method for checking tape reel motion that overcome many or all of the above-discussed shortcomings in the art.

The apparatus to check tape reel motion is provided with a plurality of modules configured to functionally execute the steps of directing the leading servo to apply torque to the leading reel and the trailing servo to apply torque to the trailing reel, and communicating that the tape is stuck or not. The modules in the described embodiments include a control module. Additionally, the apparatus includes a leading servo, and a trailing servo. The apparatus may further include a communication module, a leading sensor and a trailing sensor.

The leading servo applies torque to a leading reel for spooling magnetic tape. The trailing servo applies torque to a trailing reel for spooling the magnetic tape. The control module directs the leading servo to apply torque to the leading reel and the trailing servo to apply torque to the trailing reel. In particular, the control module directs the leading servo to apply an initial positive torque in a tape motion direction and directs the trailing servo to apply an initial negative torque counter to the tape motion direction. If there is no change in an angular position of the leading and trailing reels the control module incrementally sums a first incremental positive torque to the leading torque to increase the leading torque and a second incremental positive torque to the trailing torque, such that the trailing torque counter to the tape motion direction decreases, until there is a change in the angular position of the leading and trailing reels and/or until the leading torque exceeds a leading torque limit and/or until the trailing torque exceeds a trailing torque limit.

In an embodiment, the leading sensor measures the angular position of the leading reel and the trailing sensor measures the angular position of the trailing reel. In response to a change in the angular position of the leading reel and the trailing reel, the communication module may communicate that the magnetic tape is not stuck. Alternatively, in response to the leading torque exceeding the leading torque limit and/or the trailing torque exceeding the trailing torque limit, the communication module may communicate that the magnetic tape is stuck. The apparatus checks the tape reel motion and motivates the tape reels to unstick the tape while mitigating against damage to the tape.

A system of the present invention is also presented for checking tape reel motion. The system may be embodied in a tape drive. In particular, the system, in one embodiment, includes a magnetic tape, a leading reel, a trailing reel, a leading servo, a trailing servo, a trailing sensor, a control module, and a communication module.

The magnetic tape stores magnetically encoded data. The leading reel spools a proximal end of the magnetic tape. The leading servo applies torque to the leading reel. The trailing reel spools a distal end of the magnetic tape. The trailing servo applies torque to the trailing reel. The leading sensor measures an angular position of the leading reel. The trailing sensor measures an angular position of the trailing reel.

The control module directs the leading servo to apply torque to the leading reel and the trailing servo to apply torque to the trailing reel. In an embodiment, the control module directs the leading servo to apply an initial positive torque in a tape motion direction and directs the trailing servo to apply an initial negative torque counter to the tape motion direction, and if there is no change in an angular position of the leading and trailing reels to incrementally sum a first incremental positive torque to the leading torque to increase the leading torque and a second incremental positive torque to the trailing torque, such that the trailing torque counter to the tape motion direction decreases until there is a change in the angular position of the leading and trailing reels and/or until the leading torque exceeds a leading torque limit and/or until the trailing torque exceeds a trailing torque limit.

In response to the leading torque exceeding the leading torque limit and the trailing torque exceeding the trailing torque limit, the communication module communicates that the magnetic tape is stuck. Alternatively, in response to a change in the angular position of the leading reel and the trailing reel, the communication module communicates that the magnetic tape is not stuck.

A method of the present invention is also presented for checking tape reel motion. The method in the disclosed embodiments substantially includes the steps to carry out the functions presented above with respect to the operation of the described apparatus and system. In one embodiment, the method includes directing a leading servo to apply an initial positive torque in a tape motion direction to a leading reel and a trailing servo to apply an initial negative torque counter to the tape motion direction to a trailing reel, and incrementally summing a first incremental positive torque to the leading torque to increase the leading torque and a second incremental positive torque to the trailing torque. The method also may include communicating that the magnetic tape is stuck or not.

A control module directs a leading servo to apply torque to a leading reel and a trailing servo to apply torque to a trailing reel. In particular, the control module directs the leading servo to apply an initial positive torque in a tape motion direction and directs the trailing servo to apply an initial negative torque counter to the tape motion direction. If there is no change in an angular position of the leading and trailing reels, the control module incrementally sums a first incremental positive torque to the leading torque to increase the leading torque and a second incremental positive torque to the trailing torque, such that the trailing torque counter to the tape motion direction decreases, until there is a change in the angular position of the leading and trailing reels and/or until the leading torque exceeds a leading torque limit and/or until the trailing torque exceeds a trailing torque limit.

The communication module may communicate that the magnetic tape is stuck in response to the leading torque exceeding the leading torque limit and/or the trailing torque exceeding the trailing torque limit. Additionally, the communication module may include communicate that the magnetic tape is not stuck in response to a change in the angular position of the leading reel and the trailing reel.

References throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention provides an apparatus, a system, and a method for checking tape reel motion. Beneficially, such the present invention checks the tape reel motion, and communicates if the tape reel is stuck or not. The present invention also moderates the application of torque to the tape reels. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a side view of one embodiment of a tape drive in accordance with the present invention;

FIG. 2 is a schematic block diagram illustrating a top view of one embodiment of the tape drive of the present invention;

FIG. 3 is a schematic block diagram illustrating one embodiment of a method for checking tape reel motion of the present invention;

FIG. 4 is a schematic block diagram illustrating a leading torque and a trailing torque when the tape is moving in accordance with the present invention;

FIG. 5A is a schematic diagram illustrating the leading torque exceeding the leading torque limit when the tape is stuck of the present invention; and

FIG. 5B is a schematic diagram illustrating the trailing torque exceeding the trailing torque limit when the tape is stuck of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

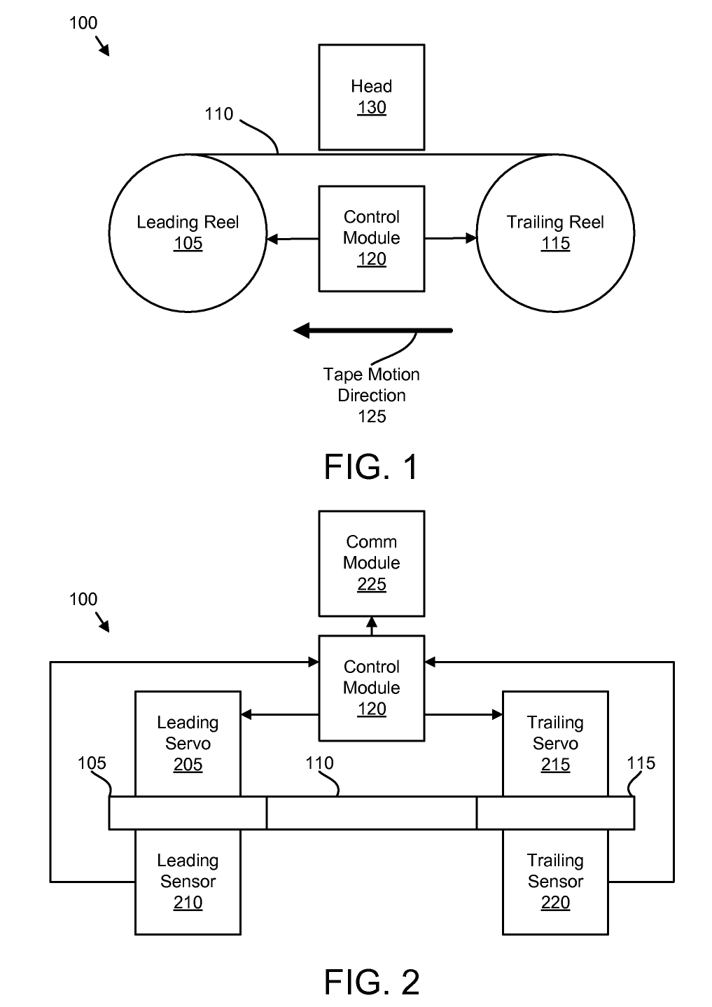

FIG. 1 is a schematic block diagram illustrating a side view of one embodiment of a tape drive 100 in accordance with the present invention. FIG. 2 is a schematic block diagram illustrating a top view of one embodiment of the tape drive 100 in accordance with the present invention. The tape drive 100 includes a magnetic tape 110, a leading reel 105, a trailing reel 115, a leading servo 205, a trailing servo 215, a leading sensor 210, a trailing sensor 220, a control module 120, and a communication module 225.

In an embodiment, the magnetic tape 110 stores magnetically encoded data as is well known to those skilled in the art. The magnetic tape 110 may store magnetically encoded data encoded by a head 130. The head 130 may include a write element comprising a magnet with a gap adjacent to the moving magnetic tape 110. For example, the head 130 may receive incoming analog electrical signals. The incoming electrical signals may produce a time-varying magnetic field in the gap of the magnet and the magnetic tape 110. As the magnetic tape 110 moves past the head 130, particles of magnetic powder on the magnetic tape 110 may be magnetized due to the time-varying magnetic field in the gap of the magnet and the magnetic tape 110 in one of two (2) directions.

The leading reel 105 spools a proximal end of the magnetic tape 110. The leading servo 205 applies torque to the leading reel 105. For example, the leading servo 205 may apply torque of two point five Newton meters (2.5 Nm) to the leading reel 105, which in turn, may spool the proximal end of the magnetic tape 110.

The trailing reel 115 spools a distal end of the magnetic tape 110. The trailing servo 215 applies torque to the trailing reel 115. For example, the trailing servo 215 may apply torque of two point four Newton meters (2.4 Nm) to the trailing reel 115, which in turn, may spool the distal end of the magnetic tape 110.

The leading sensor 210 measures an angular position of the leading reel 105. Additionally, the trailing sensor 220 measures an angular position of the trailing reel 115. The leading sensor 210 and trailing sensor 220 may be Hall effect sensors. The Hall effect sensor may be an analog tranducer or a digital transducer as is well known to those skilled in the art. In the tape drive 100, the Hall effect leading sensor 210 and the Hall effect trailing sensor 220 may be embodied in the leading servo 205 and the trailing servo 215 respectively.

In an embodiment, the leading sensor 210 and the trailing sensor 220 are optical positioning sensors. The optical positioning sensors may use single and/or double light beams to measure the angular position of the angular position of the leading reel 105 and the trailing reel 115. For example, the leading sensor 210 may measure that the angular position of the leading reel 105 is one radian (1 rad) relative to a base position at a certain time. In another example, the trailing sensor 220 may measure that the angular position of the trailing reel 115 is two radians (2 rads) relative to a base position at the same time.

The control module 120 may include a processor that executes software instructions as is well known to those of skill in the art. The control module 120 directs the leading servo 205 to apply torque to the leading reel 105 and the trailing servo 215 to apply torque to the trailing reel 115. For example, the control module 120 may direct the leading servo 205 to apply torque of two point five Newton meters (2.5 Nm) to the leading reel 105 and the trailing servo 215 to apply torque of two point four Newton meters (2.4 Nm) to the trailing reel 115.

In a certain embodiment, the control module 120 directs the leading servo 205 to apply an initial positive torque in a tape motion direction 125 and directs the trailing servo 215 to apply an initial negative torque counter to the tape motion direction 125. The initial negative torque may be equal and opposite to the initial positive torque. The initial positive torque may be fifty percent (50%) of an operating torque of the leading servo 205. For example, the control module 120 may direct the leading servo 205 to apply the initial positive torque of one point two five Newton meters (1.25 Nm) in the tape motion direction 125, and may direct the trailing servo 215 to apply the initial negative torque of one point two five Newton meters (1.25 Nm) counter to the tape motion direction 125.

If there is no change in an angular position of the leading reel 105 and trailing reel 115, the control module 120 incrementally sums a first incremental positive torque to the leading torque to increase the leading torque, and a second incremental positive torque to the trailing torque, such that the trailing torque counter to the tape motion direction 125 decreases. The control module 120 incrementally sums the first incremental positive torque to the leading torque and the second incremental positive torque to the trailing torque until there is a change in the angular position of the leading and trailing reels 105, 115 and/or until the leading torque exceeds a leading torque limit and/or until the trailing torque exceeds a trailing torque limit.

In an embodiment, the first and second incremental positive torques are in the range of two to five percent (2-5%) of an operating torque of the leading servo 205. In another embodiment, the trailing torque limit is zero torque. For example, if there is no change in an angular position of the leading and trailing reels 105, 115, the control module 120 may incrementally sum the first incremental positive torque of zero point one two five Newton meter (0.125 Nm) to the leading torque to increase the leading torque from one point two five Newton meters (1.25 Nm) to one point three seven five Newton meters (1.375 Nm) and may sum the second incremental positive torque of zero point one two five Newton meters (0.125 Nm) to the trailing torque of minus one point two five Newton meter (−1.25 Nm), such that the trailing torque counter to the tape motion direction 125 decreases to minus one point one two five Newton meters (−1.125 Nm). The control module 120 may continue to sum the first and the second incremental positive torques to the leading and trailing torques respectively until there is a change of at least zero point one radians (0.1 rads) in the angular position of the leading and trailing reels 105, 115 and/or until the leading torque exceeds a leading torque limit of one point seven five six Newton meters (1.756 Nm) and/or until the trailing torque exceeds a trailing torque limit of zero Newton meters (0 Nm).

In response to the leading torque exceeding the leading torque limit and/or the trailing torque exceeding the trailing torque limit, the communication module 225 communicates that the magnetic tape 110 is stuck. For example, in response to the leading torque exceeding the leading torque limit of one point seven five six Newton meters (1.756) and/or the trailing torque exceeding the trailing torque limit of zero Newton meters (0 Nm), the communication module 225 may communicate that the magnetic tape 110 is stuck to a controller, a host, or the like. Alternatively, in response to the change of at least zero point one radians (0.1 rads) in the angular position of the leading reel 105 and the trailing reel 115, the communication module 225 may communicate to a controller that the tape 110 is not stuck.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

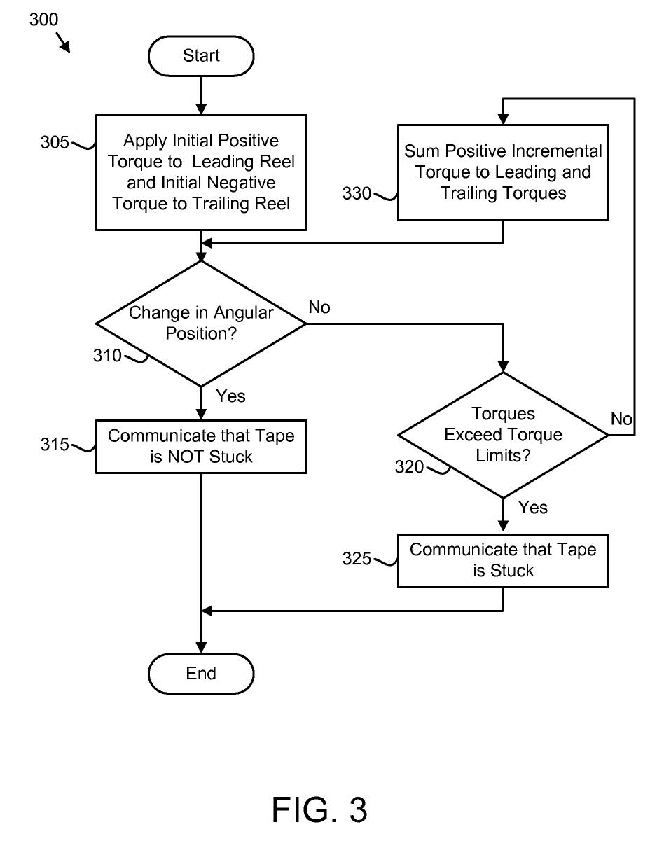

FIG. 3 is a schematic flow chart illustrating one embodiment of the method 300 for checking tape reel motion. The method 300 substantially includes the steps to carry out the functions presented above with respect to the operation of the described tape drive 100 of FIGS. 1 and 2. The description of method 300 refers to elements of FIGS. 1-2, like numbers referring to the like elements. In one embodiment, the method is implemented with a processor program product comprising a processor readable medium having a processor readable program. The processor readable program is executed by a processor of the control module 120.

The method 300 begins, and in an embodiment, the control module 120 directs a leading servo 205 to apply 305 an initial positive torque in a tape motion direction 125 to a leading reel 105, and a trailing servo 215 to apply 305 an initial negative torque counter to the tape motion direction 125 to a trailing reel 115. The leading reel 105 and the trailing reel 115 spool the magnetic tape 110. The initial positive torque may be fifty percent (50%) of an operating torque of the leading servo 205. The initial negative torque may be equal and opposite to the initial positive torque. For example, for the operating torque often Newton meters (10 Nm) of the leading servo 205, the control module 120 may direct the leading servo 205 to apply 305 the initial positive torque of five Newton meters (5 Nm) in the tape motion direction 125 to the leading reel 105 and the trailing servo 215 to apply 305 the initial negative torque of five Newton meters (5 Nm) counter to the tape motion direction 125 to the trailing reel 115.

The control module 120 may further determine 310 if there is a change in the angular position of the leading and trailing reels 105, 115. For example, the control module 120 may determine 310 that there is a change in the angular position of at least zero point one radians (0.1 rads) relative to a base position of the leading and trailing reels 105, 115.

If the control module 120 determines 310 there is a change in the angular position of the leading and trailing reels 105, 115, the communication module 225 may communicate 315 that the magnetic tape 110 is not stuck, and the method 300 terminates. For example, in response to the control module 120 determining 310 a change of twenty radians (20 rads) in two seconds (2 s) relative to a base position in the angular position of the leading and trailing reels 105, 115, the communication module 225 may automatically communicate 315 to the controller that the tape 110 is in motion.

If the control module 120 determines 310 that there is no change in the angular position of the leading and trailing reels 105, 115, the control module 120 may further determine 320 if the leading torque exceeds a leading torque limit and/or the trailing torque exceeds a trailing torque limit. The trailing torque limit may be 0 (zero) torque. If the control module 120 determines 320 that the leading torque does not exceed the leading torque limit and/or the trailing torque does not exceed the trailing torque limit, the control module 120 incrementally sums 330 a first incremental positive torque to the leading torque to increase the leading torque and a second incremental positive torque to the trailing torque, such that the trailing torque counter to the tape motion direction 125 decreases.

The first and second incremental positive torques may be in the range of two to five percent (2-5%) of the operating torque of the leading servo 215. For example, if the control module 120 determines 320 that the leading torque of fifteen Newton meters (15 Nm) does not exceed the leading torque limit of sixteen point five Newton meters (16.5 Nm) and/or the trailing torque of minus three Newton meters (−3 Nm) not does not exceed the trailing torque limit of zero Newton meters (0 Nm) torque, the control module 120 may incrementally sum 330 the first incremental positive torque of zero point six Newton meters (0.6 Nm) to the leading torque to increase the leading torque from fifteen Newton meters (15 Nm) to fifteen point six Newton meters (15.6 Nm) and a second incremental positive torque of zero point six Newton meters (0.6 Nm) to the trailing torque, such that the trailing torque counter to the tape motion direction 125 decreases from minus three Newton meters (−3 Nm) to minus two point four Newton meters (−2.4 Nm).

The control module 120 again determines 310 if there is a change in the angular position of the leading and trailing reels 105, 115. If there is no change in the angular position of the leading and trailing reels 105, 115, the control module 120 again determines 320 if the leading torque exceeds the leading torque limit and/or the trailing torque exceeds the trailing torque limit. If the control module 120 determines 320 that the leading torque does not exceed the leading torque limit and/or the trailing torque does not exceed the trailing torque limit, the control module 120 incrementally sums 330 the another first incremental positive torque to the leading torque to increase the leading torque and the another second incremental positive torque to the trailing torque, such that the trailing torque counter to the tape motion direction 125 decreases.

For example, if the control module 120 determines 320 the leading torque does not exceed the leading torque limit and/or the trailing torque does not exceed the trailing torque limit, the control module 120 may incrementally sum 330 the another first incremental positive torque of zero point six Newton meters (0.6 Nm) to the leading torque of fifteen point six Newton meters (15.6 Nm) to increase the leading torque from fifteen point six Newton meters (15.6 Nm) to sixteen point two Newton meters (16.2 Nm) and the another second incremental positive torque of zero point six Newton meters (0.6 Nm) to the trailing torque of minus two point four Newton meters (−2.4 Nm), such that the trailing torque counter to the tape motion direction 125 decreases to minus one point eight Newton meters (−1.8 Nm).

The control module 120 may repeat steps 310, 320 until there is a change in the angular position of the leading and trailing reels 105, 115 and/or until the leading torque exceeds a leading torque limit and/or until the trailing torque exceeds a trailing torque limit. In response to the control module 120 determining 310 the change in the angular position of the leading and trailing reels 105, 115, the communication module 225 may communicate 315 that the magnetic tape 110 is not stuck, and the method 300 terminates. For example, in response to the control module 120 determining 310 a change in the angular position of the leading and trailing reels 105, 115 of zero point three radians (0.3 rads) relative to a base position, the communication module 225 may automatically communicate 315 a digital code to the controller indicating that the tape 110 is not stuck

In response to the leading torque exceeding the leading torque limit and/or the trailing torque exceeding the trailing torque limit, the communication module 225 communicates 325 that the magnetic tape 110 is stuck, and the method 300 terminates. For example, if the control module 120 determines 320 that the leading torque of sixteen point eight Newton meters (16.8 Nm) exceeding a leading torque limit of sixteen point five Newton meters (16.5 Nm) and/or the trailing torque of zero point six Newton meters (0.6 Nm) exceeding the trailing torque limit of zero Newton meters (0 Nm), the communication module 225 may automatically communicate 325 a digital code to the controller indicating that the tape 110 is stuck.

The method 300 checks tape reel motion. In addition, the method 300 moderates the application of torque to the leading and trailing tape reels 105, 115, so that the tape 110 is not damaged.

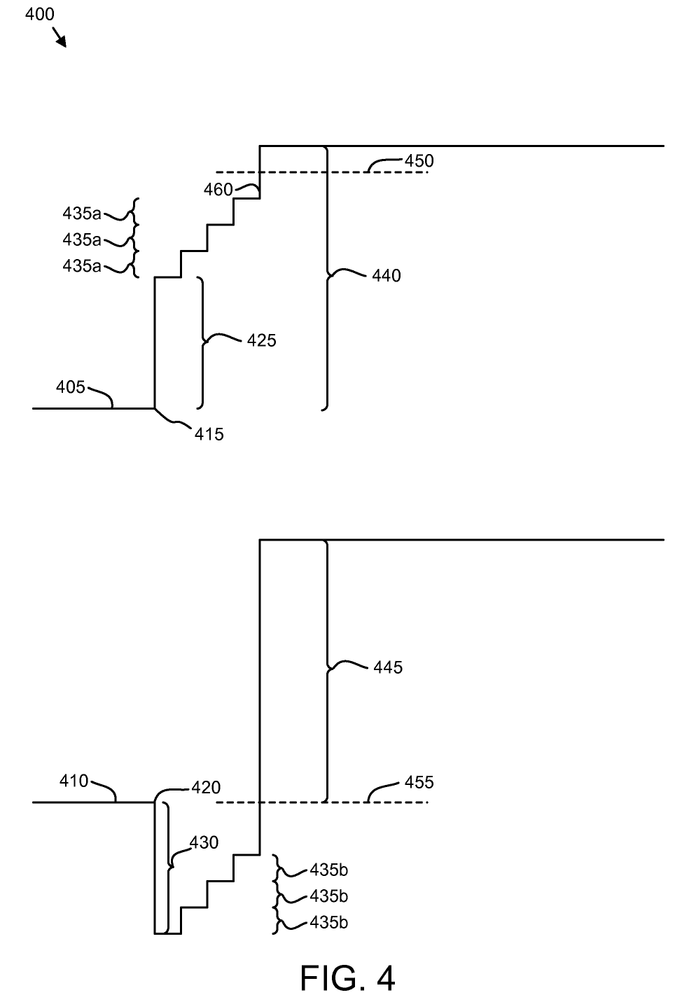

FIG. 4 is a schematic diagram 400 illustrating a leading torque 405 and a trailing torque 410 in accordance with the present invention. The leading torque 405 is applied by the leading servo 205 while the trailing torque 410 is applied by the trailing servo 215 of FIG. 2. The diagram 400 includes an initial positive torque 425, an initial negative torque 430, a plurality of first incremental positive torques 435a, a plurality of first incremental positive torque 435b, a leading torque limit 450, and a trailing torque limit 455. The diagram 400 illustrates the workings of the present invention over time. The description of the diagram 400 refers to the elements of FIG. 1-3, like numbers referring to the like elements.

In an embodiment, the diagram 400 illustrates the leading torque 405, the leading torque limit 450, the trailing torque 410, and the trailing torque limit 455 as vertical displacements with more positive torques being up and more negative torques being down. Elapsed time is indicated by horizontal dispositions, with elements to the left occurring before elements to the right. For example, the leading torque 405, and the trailing torque 410 begin as torques of zero Newton meters (0 Nm). In addition, the operating torque, the leading torque limit 450, and the trailing torque limit 455 may be of one Newton meter (1 Nm), zero point six eight Newton meters (0.68 Nm), and zero Newton meters (0 Nm) respectively.

The control module 120 may direct 305 the leading servo 205 to apply 305 the initial positive torque 425 in the tape motion direction 125 to the leading reel 105 and the trailing servo 215 to apply 305 the initial negative torque 430 counter to the tape motion direction 125 to the trailing reel 115. For example, the control module 120 may direct 305 the leading servo 205 to apply 305 the initial positive torque 425 of zero point five Newton meters (0.5 Nm) in the tape motion direction 125 to the leading reel 105, and the trailing servo 215 to apply 305 the initial negative torque 430 of zero point five Newton meters (0.5 Nm) counter to the tape motion direction 125 to the trailing reel 115.

The control module 120 may further determine 310 if there is a change in the angular position of the leading and trailing reels 105, 115. In the shown embodiments, the control module 120 determines 310 that there is no change in the angular position of the leading and trailing reels 105, 115. Additionally, in the shown embodiment, the control module 120 determines 320 that the leading torque 405 does not exceed the leading torque limit 450 and/or the trailing torque 410 does not exceed the trailing torque limit 455. For example, the control module 120 may determine 320 that the leading torque 405 of zero point five Newton meters (0.5 Nm) does not exceed the leading torque limit 450 of zero point six eight Newton meters (0.68 Nm) and/or the trailing torque 410 of minus zero point five Newton meters (−0.5 Nm) does not exceed the trailing torque limit 455 of zero Newton meters (0 Nm).

The control module 120 further incrementally sums 330 the first incremental positive torque 435a to the leading torque 405 to increase the leading torque 405 and the second incremental positive torque 435b to the trailing torque 410, such that the trailing torque 410 counter to the tape motion direction 125 decreases. For example, the control module 120 may incrementally sum 330 the first incremental positive torque 435a of zero point zero three Newton meters (0.03 Nm) to the leading torque 405 to increase the leading torque 405 to zero point five three Newton meters (0.53 Nm) and the second incremental positive torque 435b of zero point zero three Newton meters (0.03 Nm) to the trailing torque 410, such that the trailing torque 410 counter to the tape motion direction 125 decreases to minus zero point four seven Newton meters (−0.47 Nm).

The control module 120 further determines 310 if there is a change in the angular position of the leading and trailing reels 105, 115. In the shown embodiments, the control module 120 determines 310 that there is no change in the angular position of the leading and trailing reels 105, 115. Additionally, in the shown embodiment, the control module 120 determines 320 that the leading torque 405 does not exceed the leading torque limit 450 and/or the trailing torque 410 does not exceed a trailing torque limit 455. For example, the control module 120 may determine 310 that there is no change in the angular position of the leading reel 105 and the trailing reel 115, and may also determine 320 that the leading torque 405 of one point five three Newton meters (1.53 Nm) does not exceed the leading torque limit 450 of zero point six eight Newton meters (0.68 m) and/or the trailing torque 410 of minus zero point four seven Newton meters (−0.47 Nm) does not exceed a trailing torque limit 455 of zero Newton meters (0 Nm).

In the shown embodiment, the control module 120 incrementally sums 330 the another first incremental positive torque 435a to the leading torque 405 to increase the leading torque 405 and the another second incremental positive torque 435b to the trailing torque 410, such that the trailing torque 410 counter to the tape motion direction 125 decreases. For example, the control module 120 may incrementally sum 330 the another first incremental positive torque 435a of zero point zero three Newton meters (0.03 Nm) to the leading torque 405 to increase the leading torque 405 to zero point five six Newton meters (0.56 Nm), and the another second incremental positive torque 435b of zero point zero three Newton meters (0.03 Nm) to the trailing torque 410, such that the trailing torque 410 counter to the tape motion direction 125 decreases to zero point four four Newton meters (0.44 Nm).

The control module 120 further determines 310 if there is a change in the angular position of the leading and trailing reels 105, 115. In the shown embodiments, the control module 120 determines 310 that there is no change in the angular position of the leading and trailing reels 105, 115. Additionally, in the shown embodiment, the control module 120 determines 320 that the leading torque 405 does not exceed the leading torque limit 450 and/or the trailing torque 410 does not exceed the trailing torque limit 455. For example, the control module 120 may determine 310 that there is no change in the angular position of the leading reel 105 and the trailing reel 115, and may also determine 320 that the leading torque 405 of zero point five six Newton meter (0.56 Nm) does not exceed the leading torque limit 450 of zero point six eight Newton meters (0.68 Nm) and/or the trailing torque 410 of minus zero point four four Newton meters (−0.44 Nm) does not exceed the trailing torque limit 455 of zero Newton meters (0 Nm).

In the shown embodiment, the control module 120 incrementally sums 330 the another first incremental positive torque 435a to the leading torque 405 to increase the leading torque 405 and the another second incremental positive torque 435b to the trailing torque 410, such that the trailing torque 410 counter to the tape motion direction 125 decreases. For example, the control module 120 may incrementally sum 330 the another first incremental positive torque 435a of zero point zero three Newton meters (0.03 Nm) to the leading torque 405 to increase the leading torque 405 to zero point five nine Newton meter (0.59 Nm) and the another second incremental positive torque 435b of zero point zero three Newton meters (0.03 Nm) to the trailing torque 410, such that the trailing torque 410 counter to the tape motion direction 125 decreases to minus zero point four one Newton meters (−0.41 Nm).

The control module 120 further determines 310 if there is a change in the angular position of the leading and trailing reels 105, 115. In the shown embodiments, the control module 120 determines 310 that there is a change in the angular position of the leading and trailing reels 105, 115. For example, the control module 120 may determine 310 that there is a change of zero point one radians (0.1 rads) in the angular position relative to a base position of the leading reel 105, and the trailing reel 115.

If the control module 120 determines 310 that there is a change in the angular position of the leading and trailing reels 105, 115, the communication module 225 may communicate 315 that the magnetic tape 110 is not stuck. For example, in response to the control module 120 determining 310 the change of zero point one radians (0.1 rads) in the angular position of the leading and trailing reels 105, 115, the communication module 225 may automatically communicate 315 a digital code to the controller that the tape 110 is in motion.

Additionally, in the shown embodiment, when there is a change in the angular position of the leading and trailing reels 105, 115, the leading torque 405 may increase to a first torque value 440, such that the leading torque 405 exceeds the leading torque limit 450, and the trailing torque 410 may increase to a second torque value 445, such that the trailing torque 410 exceeds the trailing torque limit 455. For example, when there is a change often radians (10 rads) in the angular position of the leading and trailing reels 105, 115, the leading torque 405 may increase to the value 440 of one point two Newton meters (1.2 Nm), such that the leading torque 405 may exceed the leading torque limit 450 of zero point six eight Newton meter (0.68 Nm) and the trailing torque 410 may increase to the value 445 of one point two Newton meters (1.2 Nm), such that the trailing torque 410 may exceed the trailing torque limit 455 of zero Newton meters (0 Nm).

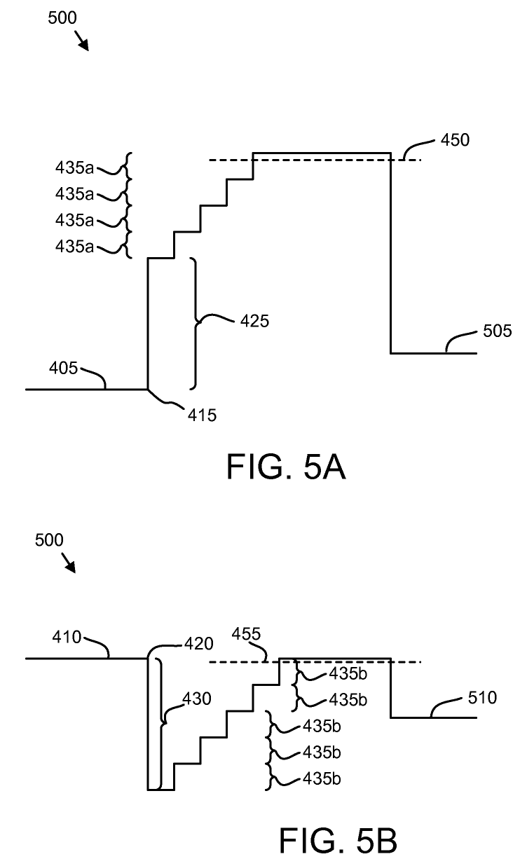

FIG. 5A is a schematic diagram 500 illustrating a leading torque 405 exceeding the leading torque limit 450 when the tape 110 is stuck in accordance with the present invention. The leading torque 405 is applied by the leading servo 205 of FIG. 2. The diagram 500 includes an initial positive torque 425, a plurality of first incremental positive torques 435a, and a leading torque limit 450. The diagram 500 illustrates the workings of the present invention over time. The description of the diagram 500 refers to the elements of FIG. 1-4, like numbers referring to the like elements.

In an embodiment, the diagram 500 illustrates the leading torque 405, the leading torque limit 450, as vertical displacements with more positive torques being up. Elapsed time is indicated by horizontal dispositions. For example, the leading torque 405 begins as zero Newton meters (0 Nm). In addition, the operating torque and the leading torque limit 450 may be of one Newton meter (1 Nm) and zero point six one Newton meters (0.61 Nm) respectively.

The control module 120 may direct 305 the leading servo 205 to apply 305 the initial positive torque 425 in the tape motion direction 125 to the leading reel 105. For example, the control module 120 may direct 305 the leading servo 205 to apply 305 the initial positive torque 425 of zero point five Newton meters (0.5 Nm) in the tape motion direction 125 to the leading reel 105.

The control module 120 may further determine 310 if there is a change in the angular position of the leading reel 105. In the shown embodiments, the control module 120 determines 310 that there is no change in the angular position of the leading reel 105. Additionally, in the shown embodiment, the control module 120 determines 320 that the leading torque 405 does not exceed the leading torque limit 450. For example, the control module 120 may determine 320 that the leading torque 405 of zero point five Newton meters (0.5 Nm) does not exceed the leading torque limit 450 of zero point six one Newton meters (0.61 Nm).

The control module 120 further incrementally sums 330 the first incremental positive torque 435a to the leading torque 405 to increase the leading torque 405. For example, the control module 120 may incrementally sum 330 the first incremental positive torque 435a of zero point zero three Newton meters (0.03 Nm) to the leading torque 405 to increase the leading torque 405 to zero point five three Newton meters (0.53 Nm).

The control module 120 further determines 310 if there is a change in the angular position of the leading reel 105. In the shown embodiments, the control module 120 determines 310 that there is no change in the angular position of the leading reel 105. Additionally, in the shown embodiment, the control module 120 determines 320 that the leading torque 405 does not exceed the leading torque limit 450. For example, the control module 120 may determine 310 that there is no change in the angular position of the leading reel 105, and may also determine 320 that the leading torque 405 of zero point five three Newton meters (0.53 Nm) does not exceed the leading torque limit 450 of zero point six one Newton meters (0.61 Nm).

In the shown embodiment, the control module 120 incrementally sums 330 another first incremental positive torque 435a to the leading torque 405 to increase the leading torque 405. For example, the control module 120 may incrementally sum 330 the another the first incremental positive torque 435a of zero point zero three Newton meters (0.03 Nm) to the leading torque 405 to increase the leading torque 405 to zero point five six Newton meters (0.56 Nm).

The control module 120 further determines 310 if there is a change in the angular position of the leading reel 105. In the shown embodiments, the control module 120 determines 310 that there is no change in the angular position of the leading reel 105. Additionally, in the shown embodiment, the control module 120 determines 320 that the leading torque 405 does not exceed the leading torque limit 450. For example, the control module 120 may determine 310 that there is no change in the angular position of the leading reel 105, and may also determine 320 that the leading torque 405 of zero point five six Newton meters (0.56 Nm) does not exceed the leading torque limit 450 of zero point six one Newton meters (0.61 Nm).

In the shown embodiment, the control module 120 incrementally sums 330 the first incremental positive torque 435a to the leading torque 405 to increase the leading torque 405. For example, the control module 120 may incrementally sum 330 the another first incremental positive torque 435a of zero point zero three Newton meters (0.03 Nm) to the leading torque 405 to increase the leading torque 405 to zero point five nine Newton meter (0.59 Nm).

The control module 120 further determines 310 if there is a change in the angular position of the leading reel 105. In the shown embodiments, the control module 120 determines 310 that there is no change in the angular position of the leading reel 105. Additionally, in the shown embodiment, the control module 120 determines 320 that the leading torque 405 does not exceed the leading torque limit 450. For example, the control module 120 may determine 310 that there is no change in the angular position of the leading reel 105, and may also determine 320 that the leading torque 405 of zero point five nine Newton meters (0.59 Nm) does not exceed the leading torque limit 450 of zero point six one Newton meters (0.61 Nm).

In the shown embodiment, the control module 120 incrementally sums 330 another first incremental positive torque 435a to the leading torque 405 to increase the leading torque 405. For example, the control module 120 may incrementally sum 330 the another first incremental positive torque 435a of zero point zero three Newton meters (0.03 Nm) to the leading torque 405 to increase the leading torque to zero point six two Newton meter (0.62 Nm).

The control module 120 further determines 310 if there is a change in the angular position of the leading reel 105. In the shown embodiments, the control module 120 determines 310 that there is no change in the angular position of the leading reel 105. Additionally, in the shown embodiment, the control module 120 determines 320 that the leading torque 405 exceeds the leading torque limit 450. For example, the control module 120 may determine 310 that there is no change in the angular position of the leading reel 105, and may also determine 320 that the leading torque 405 of zero point five nine Newton meter (0.62 Nm) exceeds the leading torque limit 450 of zero point six one Newton meters (0.61 Nm).

In response to the leading torque 405 exceeding the leading torque limit 450, the communication module 225 communicates 325 that the magnetic tape 110 is stuck. For example, if the control module 120 determines 320 that the leading torque 405 of zero point six two Newton meters (0.62 Nm) exceeding the leading torque limit 450 of zero point six two Newton meters (0.62 Nm), the communication module 225 may automatically communicate 325 a digital code to the controller indicating that the tape 110 is stuck.

Additionally, in the shown embodiment, when there is no change in the angular position of the leading reel 105, the leading torque 405 decreases to the leading torque 405. For example, when there is no change in the angular position of the leading reel 105, and the leading torque 405 exceeds the leading torque limit 450 of zero point six two Newton meter (0.62 Nm), the control module 120 may decrease the leading torque 405 to a leading parking torque 505 of zero point two five Newton meters (0.25 Nm) of torque.

FIG. 5B is a schematic diagram 500 illustrating the trailing torque 410 exceeding the trailing torque limit 455, when the tape 110 is stuck in accordance with the present invention. The trailing torque 410 is applied by the trailing servo 215 of FIG. 2. The diagram 400 includes an initial negative torque 430, a plurality of second incremental positive torque 435b, and a trailing torque limit 455. The diagram 500 illustrates the workings of the present invention over time. The description of the diagram 500 refers to the elements of FIGS. 1-4, like numbers referring to the like elements.

In an embodiment, the diagram 500 illustrates the trailing torque 410 and the trailing torque limit 455 as vertical displacements with more positive torques being up and more negative torques being down. Elapsed time is indicated by horizontal dispositions. For example, the trailing torque 410 begins as zero Newton meters (0 Nm). In addition, the operating torque, and the trailing torque limit 455 may be of one Newton meter (1 Nm) and minus zero point one Newton meters (−0.1 Nm) respectively.

The control module 120 may direct 305 the trailing servo 215 to apply 305 the initial negative torque 430 counter to the tape motion direction 125 to the trailing reel 115. For example, the control module 120 may direct 305 the trailing servo 215 to apply 305 the initial negative torque 430 of zero point five Newton meters (0.5 Nm) counter to the tape motion direction 125 to the trailing reel 115.

The control module 120 may further determine 310 if there is a change in the angular position of the trailing reel 115. In the shown embodiments, the control module 120 determines 310 that there is no change in the angular position of the trailing reel 115. Additionally, in the shown embodiment, the control module 120 determines 320 that the trailing torque 410 does not exceed the trailing torque limit 455. For example, the control module 120 may determine 320 that the trailing torque 410 of minus zero point five Newton meters (−0.5 Nm) does not exceed the trailing torque limit 455 of minus zero point one Newton meters (−0.1 Nm).

The control module 120 further incrementally sums 330 the second incremental positive torque 435b to the trailing torque 410, such that the trailing torque 410 counter to the tape motion direction 125 decreases. For example, the control module 120 may incrementally sum 330 the second incremental positive torque 435b of zero point one Newton meters (0.1 Nm) to the trailing torque 410, such that the trailing torque 410 counter to the tape motion direction 125 decreases to minus zero point four Newton meters (−0.4 Nm).

The control module 120 may further determine 310 if there is a change in the angular position of the trailing reel 115. In the shown embodiments, the control module 120 determines 310 that there is no change in the angular position of the trailing reel 115. Additionally, in the shown embodiment, the control module 120 determines 320 that the trailing torque 410 does not exceed the trailing torque limit 455. For example, the control module 120 may determine 320 that the trailing torque 410 of minus zero point four Newton meters (−0.4 Nm) does not exceed the trailing torque limit 455 of minus zero point one Newton meters (−0.1 Nm).

The control module 120 further incrementally sums 330 the second incremental positive torque 435b to the trailing torque 410, such that the trailing torque 410 counter to the tape motion direction 125 decreases. For example, the control module 120 may incrementally sum 330 the second incremental positive torque 435b of zero point one Newton meters (0.1 Nm) to the trailing torque 410, such that the trailing torque 410 counter to the tape motion direction 125 decreases to minus zero point three Newton meters (−0.3 Nm).

The control module 120 may further determine 310 if there is a change in the angular position of the trailing reel 115. In the shown embodiments, the control module 120 determines 310 that there is no change in the angular position of the trailing reel 115. Additionally, in the shown embodiment, the control module 120 determines 320 that the trailing torque 410 does not exceed the trailing torque limit 455. For example, the control module 120 may determine 320 that the trailing torque 410 of minus zero point three Newton meters (−0.3 Nm) does not exceed the trailing torque limit 455 of minus zero point one Newton meters (−0.1 Nm).

The control module 120 further incrementally sums 330 the second incremental positive torque 435b to the trailing torque 410, such that the trailing torque 410 counter to the tape motion direction 125 decreases. For example, the control module 120 may incrementally sum 330 the second incremental positive torque 435b of zero point one Newton meters (0.1 Nm) to the trailing torque 410, such that the trailing torque 410 counter to the tape motion direction 125 decreases to minus zero point two Newton meters (−0.2 Nm).

The control module 120 may further determine 310 if there is a change in the angular position of the trailing reel 115. In the shown embodiments, the control module 120 determines 310 that there is no change in the angular position of the trailing reel 115. Additionally, in the shown embodiment, the control module 120 determines 320 that the trailing torque 410 does not exceed the trailing torque limit 455. For example, the control module 120 may determine 320 that the trailing torque 410 of minus zero point two Newton meters (−0.2 Nm) does not exceed the trailing torque limit 455 of minus zero point one Newton meters (−0.1 Nm).

The control module 120 further incrementally sums 330 the second incremental positive torque 435b to the trailing torque 410, such that the trailing torque 410 counter to the tape motion direction 125 decreases. For example, the control module 120 may incrementally sum 330 the second incremental positive torque 435b of zero point one Newton meters (0.1 Nm) to the trailing torque 410, such that the trailing torque 410 counter to the tape motion direction 125 decreases to minus zero point one Newton meters (−0.1 Nm).

The control module 120 may further determine 310 if there is a change in the angular position of the trailing reel 115. In the shown embodiments, the control module 120 determines 310 that there is no change in the angular position of the trailing reel 115. Additionally, in the shown embodiment, the control module 120 determines 320 that the trailing torque 410 does not exceed the trailing torque limit 455. For example, the control module 120 may determine 320 that the trailing torque 410 of minus zero point one Newton meters (−0.1 Nm) does not exceed the trailing torque limit 455 of minus zero point one Newton meters (−0.1 Nm).

The control module 120 further incrementally sums 330 the second incremental positive torque 435b to the trailing torque 410, such that the trailing torque 410 counter to the tape motion direction 125 decreases. For example, the control module 120 may incrementally sum 330 the second incremental positive torque 435b of zero point one Newton meters (0.1 Nm) to the trailing torque 410, such that the trailing torque 410 counter to the tape motion direction 125 decreases to zero Newton meters (0 Nm).

In response to the trailing torque 410 exceeding the trailing torque limit 455, the communication module 225 communicates 325 that the magnetic tape 110 is stuck. For example, if the control module 120 determines 320 that the trailing torque 410 of zero Newton meters (0 Nm) exceeding the trailing torque limit 455 of minus zero Newton meters (−0.1 Nm), the communication module 225 may automatically communicate 325 a digital code to the controller indicating that the tape 110 is stuck.

Additionally, in the shown embodiment, when there is no change in the angular position of the trailing reel 115, the trailing torque 410 decreases to a trailing parking torque 510. For example, when there is no change in the angular position of the trailing reel 115, control module 120 may decrease the trailing torque 410 to the trailing parking torque 510 of minus zero point two five Newton meters (−0.25 Nm).

The present invention checks the tape reel motion, and communicates if a tape reel 105, 115 is stuck or not. The present invention also moderates the application of torque 405, 410 to the tape reels 105, 115. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to check tape reel motion, the apparatus comprising:
a leading servo configured to apply torque to a leading reel for spooling magnetic tape;
a trailing servo configured to apply torque to a trailing reel for spooling the magnetic tape; and
a control module configured to direct the leading servo to apply torque to the leading reel and the trailing servo to apply torque to the trailing reel, wherein the control module directs the leading servo to apply an initial positive torque in a tape motion direction and directs the trailing servo to apply an initial negative torque counter to the tape motion direction, and if there is no change in an angular position of the leading and trailing reels to incrementally sum a first incremental positive torque to the leading torque to increase the leading torque and a second incremental positive torque to the trailing torque, such that the trailing torque counter to the tape motion direction decreases, until there is a change in the angular position of the leading and trailing reels and/or until the leading torque exceeds a leading torque limit and/or until the trailing torque exceeds a trailing torque limit.

2. The apparatus of claim 1, the apparatus further comprising a leading sensor configured to measure the angular position of the leading reel and a trailing sensor configured to measure the angular position of the trailing reel.

3. The apparatus of claim 2, wherein the leading sensor and trailing sensor are configured as hall effect sensors.

4. The apparatus of claim 2, wherein the leading sensor and trailing sensor are configured as optical positioning sensors.

5. The apparatus of claim 1, the apparatus further comprising a communication module configured to communicate that the magnetic tape is stuck in response to the leading torque exceeding the leading torque limit and/or the trailing torque exceeding the trailing torque limit and to communicate that the magnetic tape is not stuck in response to a change in the angular position of the leading reel and the trailing reel.

6. The apparatus of claim 1, wherein the initial negative torque is equal and opposite to the initial positive torque.

7. The apparatus of claim 6, wherein the initial positive torque is fifty percent of an operating torque of the leading servo.

8. The apparatus of claim 7, wherein the first and second incremental positive torques are in the range of two to five percent of the operating torque of the leading servo.

9. The apparatus of claim 6, wherein the trailing torque limit is zero torque.

10. The apparatus of claim 1, wherein the control module incrementally sums the first incremental positive torque to the leading servo and the second incremental positive torque to the trailing servo until the magnetic tape is transported relative to a head and/or until the leading torque exceeds a leading torque limit and/or until the trailing torque exceeds a trailing torque limit.

11. A processor program product comprising a processor useable medium having a processor readable program, wherein the processor readable program when executed on a processor causes the processor to:
direct a leading servo to apply an initial positive torque in a tape motion direction to a leading reel and a trailing servo to apply an initial negative torque counter to the tape motion direction to a trailing reel, wherein the leading and trailing reels spool magnetic tape;
incrementally sum a first incremental positive torque to the leading torque to increase the leading torque and a second incremental positive torque to the trailing torque such that the trailing torque counter to the tape motion direction decreases until there is a change in the angular position of the leading and trailing reels and/or until the leading torque exceeds a leading torque limit and/or until the trailing torque exceeds a trailing torque limit.

12. The processor program product of claim 11, wherein the processor readable code is further configured to cause the processor to communicate that the magnetic tape is stuck in response to the leading torque exceeding the leading torque limit and/or the trailing torque exceeding the trailing torque limit and to communicate that the magnetic tape is not stuck in response to a change in the angular position of the leading reel and the trailing reel.

13. The processor program product of claim 11, wherein the initial negative torque is equal and opposite to the initial positive torque.

14. The processor program product of claim 13, wherein the initial positive torque is fifty percent of an operating torque of the leading servo.

15. The processor program product of claim 14, wherein the first and second incremental positive torques are in the range of two to five percent of the operating torque of the leading servo.

16. The processor program product of claim 15, wherein the trailing torque limit is zero torque.

17. A system to check tape reel motion, the system comprising:
a magnetic tape configured to store magnetically encoded data;
a leading reel configured to spool a proximal end of the magnetic tape;
a leading servo configured to apply torque to the leading reel;
a trailing reel configured to spool a distal end of the magnetic tape;
a trailing servo configured to apply torque to the trailing reel;
a leading sensor configured to measure an angular position of the leading reel;
a trailing sensor configured to measure an angular position of the trailing reel;
a control module configured to direct the leading servo to apply torque to the leading reel and the trailing servo to apply torque to the trailing reel, wherein the control module directs the leading servo to apply an initial positive torque in a tape motion direction and directs the trailing servo to apply an initial negative torque counter to the tape motion direction, and if there is no change in the angular position of the leading and trailing reels to incrementally sum a first incremental positive torque to the leading torque to increase the leading torque and a second incremental positive torque to the trailing torque, such that the trailing torque counter to the tape motion direction decreases, until there is a change in the angular position of the leading and trailing reels as measured by the leading and trailing sensor and/or until the leading torque exceeds a leading torque limit and/or until the trailing torque exceeds a trailing torque limit; and
a communication module configured to communicate that the magnetic tape is stuck in response to the leading torque exceeding the leading torque limit and/or the trailing torque exceeding the trailing torque limit and to communicate that the magnetic tape is not stuck in response to a change in the angular position of the leading reel and the trailing reel.

18. The system of claim 17, wherein the leading sensor and trailing sensor are configured as hall effect sensors.

19. The system of claim 17, wherein the leading sensor and trailing sensor are configured as optical positioning sensors.

20. The system of claim 17, wherein the initial negative torque is equal and opposite to the initial positive torque, the initial positive torque is fifty percent of an operating torque of the leading servo, the first and second incremental positive torques are in the range of two to five percent of the operating torque of the leading servo, and the trailing torque limit is zero torque.
